(19) United States
(12) Patent Application Publication
(10) Pub. No.: US 2023/0036071 A1
(43) Pub. Date: Feb. 2, 2023

(54) MANAGING EDGE GATEWAY SELECTION USING EXCHANGED HASH INFORMATION

(71) Applicant: VMWARE, INC., Palo Alto, CA (US)

(72) Inventors: ABHISHEK GOLIYA, Pune (IN); Yong Wang, San Jose, CA (US); Awan Kumar Sharma, Pune (IN)

(21) Appl. No.: 17/507,822

(22) Filed: Oct. 22, 2021

(30) Foreign Application Priority Data
Jul. 27, 2021 (IN) 202141033761

(51) Int. Cl. H04L 29/06; H04L 12/46; H04L 12/66; H04L 29/12; H04L 9/06

(52) U.S. Cl. CPC H04L 63/0428; H04L 12/4633; H04L 12/66; H04L 61/2007; H04L 63/164; H04L 9/0643

(57) ABSTRACT

Described herein are systems, methods, and software to select edge gateways for communications based on exchanged hash information. In one implementation, a first gateway may receive hash information associated with second gateways, wherein the hash information is used to select a gateway of the second gateways to communicate a packet. The first gateway further receives a packet. hashes addressing in the packet to select a destination gateway of the second gateways for the packet. The first gateway further encapsulates the packet and communicates the encapsulated packet to the selected destination gateway.

### RELATED APPLICATION

Benefit is claimed under 35 U.S.C. 119(a)-(d) to Foreign Application Serial No. 202141033761 filed in India entitled “MANAGING EDGE GATEWAY SELECTION USING EXCHANGED HASH INFORMATION”, on Jul. 27, 2021, by VMware, Inc., which is herein incorporated in its entirety by reference for all purposes.

### BACKGROUND

In computing environments, edge gateways (or, simply, “edges”) are used to provide network connectivity for host computing systems. These host computing systems may execute virtual machines, containers, or some other virtualized interface. The edge gateways may be used to provide various operations on the ingress and egress packets to the various hosts, including firewall operations, filtering, encryption/decryption, or some other operation with respect to the packets. For example, a packet may be received at an edge from an external network, processed by the edge, and forwarded to a destination host.

However, while edges may provide networking operations to connect hosts and the virtual computing elements to an external network, difficulties can arise as the number of edges is increased in a computing environment. For improved throughput, each of the edges may provide stateful services for a different set of internet protocol (IP) addresses, requiring packets to be exchanged between the edges for processing. This may cause inefficiencies in communicating data between the hosts and the external networks, as the packets must be exchanged or “punted” prior to being processed by the appropriate edge.

### SUMMARY

The technology described herein manages edge gateway selection based on exchanged hash information. In one implementation, a first gateway is configured to obtain hash information associated with second gateways. The first gateway is further configured to receive a packet from a virtual machine and hash addressing information in the packet using the hash information associated the second gateways to select a destination gateway of the second gateways. Once hashed, the first gateway encapsulates the packet and communicates the packet to the destination gateway.

### BRIEF DESCRIPTION OF THE DRAWINGS

FIG. 1 illustrates a computing environment to manage edge gateway selection for communications based on exchanged hash information according to an implementation.

FIG. 2 illustrates a method of operating an edge to select edges for communications based on exchanged hash information according to an implementation.

FIG. 3 illustrates an operational scenario of selecting an edge for a communication based on exchanged hash information according to an implementation.

FIG. 4 illustrates an operational scenario of selecting an edge for a communication based on exchanged hash information according to an implementation.

FIG. 5 illustrates a gateway computing system according to an implementation.

### DETAILED DESCRIPTION

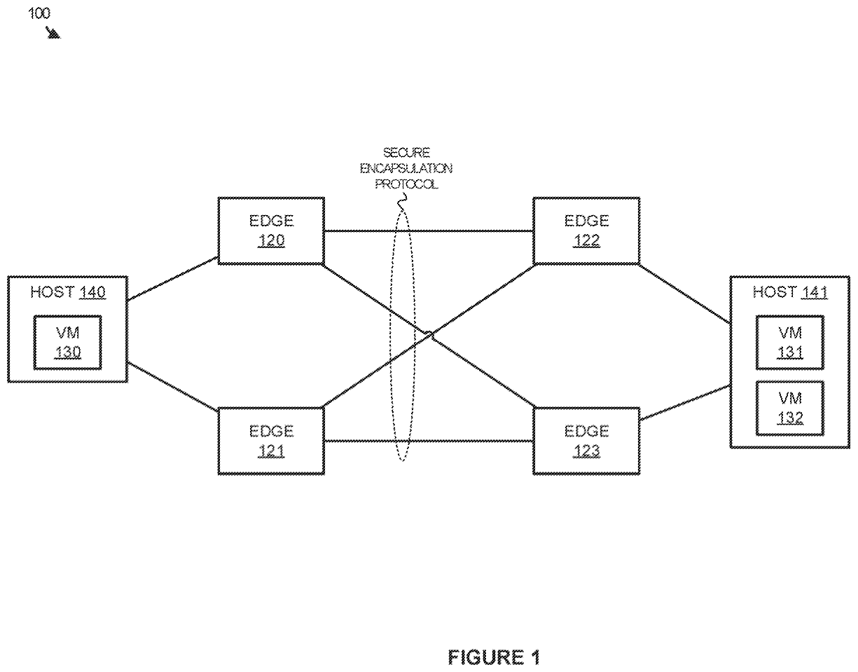

FIG. 1 illustrates a computing environment 100 to manage edge gateway selection for communications based on exchanged hash information according to an implementation. Computing environment 100 includes hosts 140-141, virtual machines 130-132, and edges 120-123. Edges 120-121 may operate at first computing site (e.g., data center, office, and the like) in some examples, while edges 122-123 may operate at a second computing site. Although demonstrated with a single host at each computing site, computing sites may deploy any number of hosts to provide a desired configuration.

In computing environment 100, virtual machines 130-132 can be deployed to provide various operations. These operations may include user desktops, front-end applications, database management applications, data processing applications, web servers, or some other operation. As an example, virtual machine 130 may provide a user desktop, while virtual machines 131-132 may provide one or more databases that are accessed by virtual machine 130. To provide the communications between virtual machine 130 and virtual machines 131-132, edge gateways (“edges”) 120-123 are provided. Edges 120-123 may be used to provide network address translation, routing, firewall, encapsulation, and other operations associated with communications for virtual machines 130-132 and hosts 140-141.

In one example, virtual machine 130 may initiate a communication of a packet to virtual machine 131. To support the communication, host 140 may identify the packet and determine that the packet is required to be communicated to one of edges 120-121 using an appropriate tunnel from host 140. The selection of an edge from edges 120-121 may use equal-cost multi-path (ECMP) routing, pseudo-random selection, round-robin selection, or some other selection mechanism. In some implementations, host 140 may execute a virtual switch (not shown) that can provide networking for virtual machine 130, wherein the virtual switch may provide logic that determines when a packet should be communicated to a destination external to host 140. When the destination address is not local to the host, the virtual switch may encapsulate and forward the packet to the external destination using a physical network interface (not shown) of host 140. In some implementations, the forwarding of the packet may be based on one or more flow tables, wherein attributes in the packet may be compared to entries in the one or more flow tables to direct the packet locally or over the network.

Once host 140 determines that the packet is required to be communicated to another computing system via one of edges 120-121, host 140 may hash addressing information in the packet to select an edge of edges 120-121, wherein the hashed addressing information may include the destination IP address, and may further, or alternatively, include a source IP address, source and destination port, protocol, and/or some other addressing information. A hash is any function that can be used to map the addressing information of an arbitrary size to fixed size values. Cryptographic hash functions may be used for producing hash values having high entropy, for more even distribution of hash values, and thus more even load distribution across edges. For example, the function may be used to map the destination IP address in the packet to a one or a zero, wherein a one may map to edge 120 and a zero may map to edge 121. The hash may also result in a first value that can be divided by the number of available edges at the second computing site to determine a remainder, wherein the remainder may map to an edge of edges 120-121 For example, the hash may result in a first value that is then divided by two to determine a remainder (i.e., one or zero). A one may map to edge 120, while a zero may map to edge 121. Once selected, the packet may be forwarded to the corresponding edge. In some examples, this forwarding of the packet may encapsulate the packet using Generic Network Virtualization Encapsulation (Geneve), Virtual Extensible LAN (VXLAN), or some other encapsulation format.

Here, once a packet is received by one of edges 120-121, edges 120-121 may process the packet and forward the packet to one of edges 122-123. The processing of the packet may include decapsulating the packet if required, implementing one or more firewall rules, or providing some other action in association with the packet. To select the edge from edges 122-123 to communicate the packet, edges 120-121 may obtain hash information associated with edges 122-123. This information may be provided by at least one of edges 122-123, in some examples using a control plane such as Internet Key Exchange (IKE) control communications. The control plane may operate as part of the secure encapsulation protocol (e.g., IPsec) tunnels coupling edges 120-121 with edges 122-123. The hash information is used to route the packets to one of edges 122-123 based on addressing information in the packet. The addressing information may comprise the source IP address of the packet in some examples, and may further include the destination IP address, port information, or some other information. The hash information may route packets with first addressing attributes to edge 122, while second addressing attributes are routed to edge 123. The hash information may include algorithms, keys, or some other information that is used to hash the addressing information to a set size of values. In one example, the hash information may hash the addressing information to identify a first value, then divide the first value by the number of edges (two for edges 122-123) to identify a remainder value. The remainder value may then correspond to one of edges 122-123. Because the hash information is provided by and associated with edges 122-123, the packet is forwarded to an edge expected to process the packet.

In some implementations, the hash information provided by edges 122-123 may include one or more functions that, when applied, can transform the values of the addressing information to a fixed sized value. The fixed sized value may then be divided by the number of edges to select the edge of edges 122-123, wherein each edge of edges 122-123 may correspond to a different remainder value (i.e., a zero or one). As the one or more functions are provided by at least one of edges 122-123, edges 122-123 may indicate to edges 120-121 an expected destination for each of the packets.

After selecting an edge from edges 122-123, the packet is encapsulated and forwarded to the selected edge. The encapsulation may comprise a secure encapsulation, such as IPsec in some examples. Once received at the destination edge of edges 122-123, the packet can be decapsulated, processed, and forwarded to the destination host 141 and virtual machine.

As an example, edge 120 may receive a packet from virtual machine 130 and apply the hash information associated with edges 122-123 on addressing information in the packet to select an edge of edges 122-123 to forward the packet. If the application of the hash indicates that edge 123 should process the packet, the packet is encapsulated and forwarded to edge 123. Edge 123 then processes the packet and forwards the packet toward its destination on host 141.

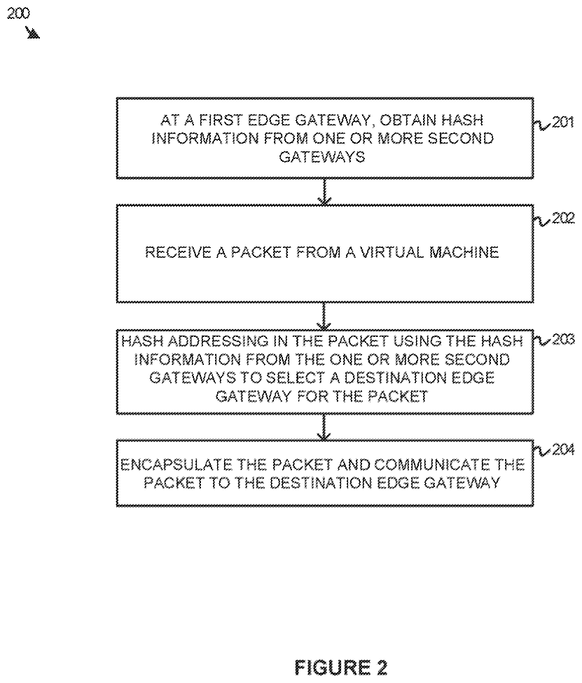

FIG. 2 illustrates a method 200 of operating an edge to select edges for communications based on exchanged hash information according to an implementation. The steps of method 200 are referenced parenthetically in the paragraphs that follow with reference to systems and elements of computing environment 100 of FIG. 1. The operations are described below with reference to edge 120, but similar processes may be performed by other edges in computing environment 100.

For method 200, a first gateway obtains (201) hash information associated with second gateways. In some implementations, the first gateway may comprise an edge at a first computing site and the second gateways may comprise an edge at a second computing site. For example, edge 120 may receive hash information associated with edges 122-123. The hash information may be used to direct packets to the gateway assigned to processing the packets with specific addressing information. For example, edge 122 may be used to process packets with first addressing information, while edge 123 may be used to process packet with second addressing information. Accordingly, at least one of edges 122-123 may provide hash information to each of edges 120-121, permitting edges 120-121 to direct packets to the appropriate edge of edges 122-123 for processing. Advantageously, by providing edges 120-121 with the hash information edges 122-123 may avoid having to exchange (or “punt”) packets that are to be serviced by the other edge of edges 122-123. The servicing may include firewall operations, load balancing for communication flows, network address translation, or some other operation. The hash information may include algorithms, keys, and other processes to select an edge based on addressing information in the packets. The hash information may be provided using a control plane between edges 120-121 and edges 122-123 in some examples, wherein the control plane may comprise Internet Key Exchange (IKE) communications.

Once the hash information is obtained, method 200 further includes receiving (202) a packet from a virtual machine and hashing (203) addressing information in the packet using the hash information associated with the second gateways to select a destination gateway of the second gateways. As an example, edge 120 may receive a packet from virtual machine 130 and host 140. Once received, edge 120 may identify addressing information in the packet, and hash the addressing information of the packet to select an edge of edges 122-123. The addressing information may include a source IP address of the packet, and may further, or alternatively include a destination IP address, port information, protocol, and/or some other addressing information for the packet. In at least one implementation, the packet may be received encapsulated in a second packet from host 140. The encapsulation may comprise a Generic Network Virtualization Encapsulation (Geneve) packet, a Virtual Extensible LAN (VXLAN) packet, or some other encapsulated packet. Once received, edge 120 may decapsulate the packet to identify the packet from virtual machine 130.

Once the packet is received, edge 120 may apply the hash information associated with edges 122-123 to the packet to select an edge of edges 122-123 to forward the packet. The hash information may include algorithm information that, when applied to addressing information in the packet, can select the destination edge for the packet. As the hash information (hash function or functions) are provided by edges 122-123, the packets may be forwarded to edges 122-123 in a manner consistent with the expectations of edges 122-123. Specifically, because the hash information is provided by edges 122-123, the packets may be hashed and directed to an edge expected to process the packet. In some examples, the hash information may be used to convert addressing information (e.g., a source IP address) to a fixed size of values. The hash information may comprise a mathematical function that converts the input addressing information into another numerical value. In some examples, the results from the function may comprise values that each correspond to a different possible destination edge, wherein edge 122 may be associated with a first value (e.g., “zero”) and edge 123 may be associated with a second value (e.g., “one”). Depending on the resultant value of the hash function, the corresponding edge may be selected.

In some implementations, the hash information may be used to identify a first value using the mathematical function, and the first value may be divided by the number of possible destination edges to identify a remainder value. Each possible remainder value may correspond to an edge of edges 122-123 as prescribed by the hash information. In some implementations the hash information may be applied to a single addressing attribute (e.g., source IP address), however, the hash information may be applied to multiple addressing attributes including IP addresses, ports, and protocol information in the packet. The hash information may be applied by edges 120-121, such that the packet is forwarded to an edge of edges 122-123 expecting the addressing of the packet. Thus, rather than determining the edge for processing when the packet is received at an edge of edges 122-123, edges 122-123 may determin

After the destination edge is identified, method 200 further includes encapsulating (204) the packet and communicating the packet to the destination edge. In some implementations, the encapsulation may use a secure encapsulation protocol, such as IPsec, that adds header information to the packet that directs the packet to the appropriate destination edge. The encapsulation process may also encrypt the packet in the payload of the encapsulated packet.

Once the packet is received by the destination edge, the destination edge may decapsulate the packet and forward the packet to the destination host for the virtual machine. This forwarding may include re-encapsulating the packet using VXLAN, Geneve, or some other encapsulation format. When received, the host may decapsulate the packet and forward the packet to the destination virtual machine. For example, if a packet from virtual machine 130 is delivered from edge 120 to edge 123, edge 123 may decapsulate the packet, process the packet, re-encapsulate the packet, and forward the packet to host 141. Host 141 may receive the packet from edge 123, decapsulate the packet if required, and forward the packet to the destination virtual machine of virtual machines 131-132.

When a return packet is communicated from a virtual machine on host 141 to virtual machine 130, the hashing of the packets may be reversed to maintain the tunnels for the communication session. For example, if virtual machine 130 initiated a communication with virtual machine 131 and edges 121 and 123 were used for the communication, a return packet received by edge 123 should also direct packets to edge 121. Accordingly, while edge 121 may hash a source IP address to select edge 123, edge 123 may perform other mechanisms to select edge 121.

In one example, edge 123 may cache an entry that associates addressing information from the packet sent by virtual machine 130 with a tunnel endpoint that directs traffic back to edge 121 when return traffic matches the addressing information. In other examples, edge 123 may hash addressing information in the return packet to select edge 121 for the return packet, wherein this hashing may be based on hash information provided in association with edges 120-121. Advantageously, edges 120-123 may exchange hash information, such that return packets are forwarded in the computing environment using the same path as the original packet.

In some implementations, the hash information may be updated by edges 122-123. The information may be updated periodically, based on a request from an administrator of the computing environment, or at some other interval. Although demonstrated with a single host at either site in the computing environment, any number of hosts may be employed by a computing environment to provide the required operations. In at least one implementation, rather than a virtual machine, the source or destination of a communication may comprise a physical computer, wherein the physical computer may communicate with a plurality of edges at the computing site.

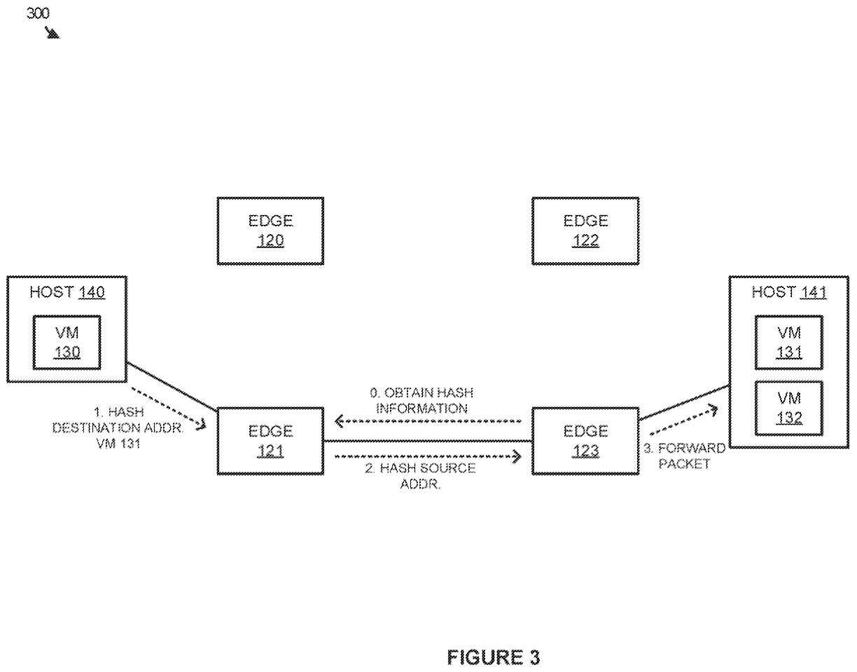

FIG. 3 illustrates an operational scenario 300 of selecting an edge for a communication based on exchanged hash information according to an implementation. Operational scenario 300 includes the systems and elements from computing environment 100 of FIG. 1.

In operational scenario 300, edge 121 obtains, at step 0, hash information from at least edge 123 that is used to direct communications to one of edges 122-123 based on addressing information in the packets to be communicated. The hash information may be provided using the IKE control plane between edge 121 and edge 123, wherein the hash information may be applied to addressing information (e.g., source IP address of a packet) to determine the destination based on an association between the generated value from the hash information and an edge of edges 122-123. In some implementations, the hash information may be provided by both edges 122-123, wherein the hash information may be provided via the IKE control plane for the IPsec tunnels between edges 120-121 and edges 122-123.

Once the hash information is obtained, virtual machine 130 generates a packet that is communicated by host 140 to edge 121, wherein the packet is destined for virtual machine 131. In some implementations, host 140 may execute a virtual switch that identifies the destination of the packet from virtual machine 130 as external to host 140. Host 140 may hash a destination address in the packet, at step 1, and forward the packet to the edge corresponding to the resultant value from the hash. For example, host 140 may hash the destination IP address to obtain a value of zero or one, wherein each of the values correspond to an edge of edges 120-121. The packet may then be forwarded using the tunnel endpoint associated with the selected edge. The forwarding of the packet may include encapsulating the packet using VXLAN or Geneve.

Once the packet is received at edge 121, edge 121 may decapsulate the packet if required and hash, at step 2, the source IP address of the packet to determine a destination edge of edges 122-123 using the hash information provided ins association with the edges. In some implementations, the hash information may be used to transform the source IP address into a value that corresponds to one of edges 122-123. Once the hash is completed and the edge is identified, edge 121 may encapsulate the packet and forward the packet toward the destination edge 123. In some examples, the encapsulation may comprise a secure encapsulation, such as IPsec, wherein a tunnel may be established between edge 121 and edge 122, and further established between edge 121 and edge 123.

Once the packet is received by edge 123, the packet may be processed by edge 123 prior to forwarding, at step 3, the packet to host 141 for the destination virtual machine 131. The processing of the packet may include decapsulating the packet, applying one or more firewall rules, or providing some other operation in association with the packet. The packet is then forwarded to host 141. In some implementations, the packet may be re-encapsulated by edge 123 and forwarded to host 141 using VXLAN or Geneve.

In some examples, if a return packet is generated by virtual machine 131, the packet may be communicated using the same path as the initial communication. For example, edge 123 and host 141 may cache or store information about the edge from which the packet was received. Specifically, addressing information from the original packet may be associated with an identifier for the edge that the packet was received from. When a packet with matching addressing attributes is identified as a return packet, the packet may be forwarded to the corresponding next-hop edge. Thus, a return packet from virtual machine 131 may be communicated from host 141 to edge 123, and subsequently to edge 121.

Although demonstrated in the example of operational scenario 300 as using the source IP address for the selection of edges 122-123, the hash may use any number of the source and destination IP addresses, source and destination ports, protocol, or some other addressing information in the packet. For example, edge 121 may apply the hash information to the source and destination IP address to identify a value that corresponds to one of edge 122-123.

Although demonstrated in the example of operational scenario 300 as initiating a communication from a virtual machine at host 140, similar operations may be performed when a communication is initiated from a virtual machine on host 141. Specifically, hash information may be provided by edges 120-121 to edges 122-123 that can be used in determining a destination edge for communications from virtual machines 131-132. As an example, when a packet is received by edge 122, edge 122 may hash addressing information in the packet using hash information provided in association with edges 120-121 to select a destination edge of edges 120-121 for the packet.

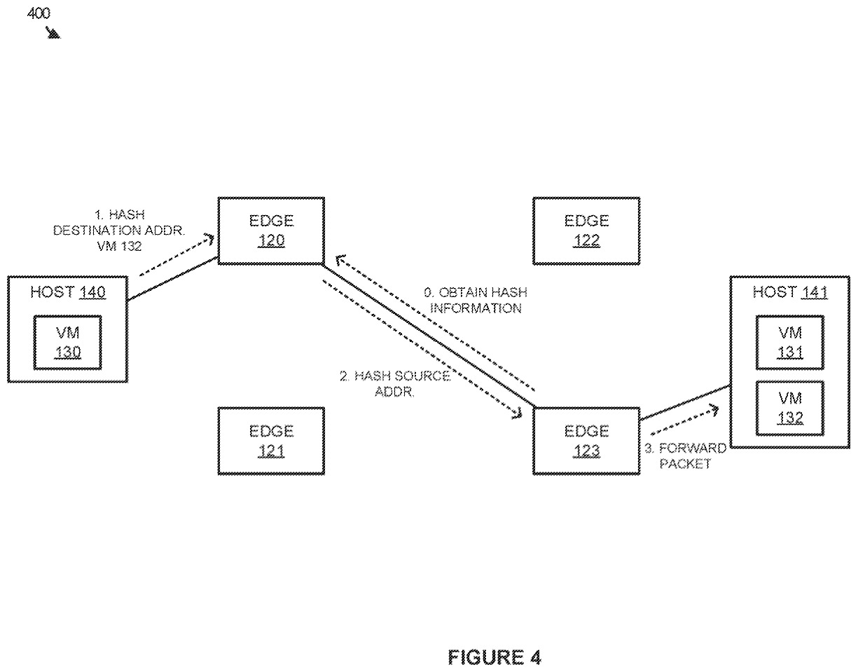

FIG. 4 illustrates an operational scenario 400 of selecting an edge for a communication based on exchanged hash information according to an implementation. Operational scenario 400 includes systems and elements from computing environment 100 of FIG. 4. Although similar to the operations described above with respect to FIG. 3, operational scenario 400 describes a communication from virtual machine 130 to virtual machine 132.

Again, at step 0, edges 120-121 may obtain, at step 0, hash information associated with edges 122-123. Once received, virtual machine 130 may initiate a communication of a packet to virtual machine 132. Host 140 identifies the communication and selects an edge by hashing, at step 1, the destination IP address in the packet to determine an edge of edges 120-121 to forward the packet. Although this is one mechanism for selecting an edge, edge 140 may use pseudo-random selection, round robin selection, or some other selection mechanism for the edge for the packet. Once an edge is selected, host 140 may forward the packet to the selected edge. Here, the packet is encapsulated by host 140 and communicated to edge 120. In comparing with operational scenario 300, because the destination address is different for virtual machine 131 and virtual machine 132, a first packet with a first destination IP address may be directed to edge 120, while a second packet with a second destination IP address is directed to edge 121.

After the packet is received at edge 120, edge 120 may hash, at step 2, a source IP address in the packet to select a destination edge for the packet using the hash information provided for edges 122-123. Because the source IP address is the same in operational scenario 400 as in operational scenario 300, the packet is forwarded to edge 123. Although demonstrated as hashing the source IP address of the packet, it should be understood that additional addressing attributes in the packet may be hashed to select. The hash information provided for the hash may include any algorithm, keys, or other functions that can select the requested edge for processing. Once the edge of edges 122-123 is selected, edge 120 encapsulates the packet and forwards the packet to the selected edge 123.

Edge 123 receives the packet and processes the packet, wherein the processing may include decapsulating the packet, performing any firewall operations, routing operations, or some other operation with the packet, and forwards the packet to host 141 for delivery to virtual machine 132. In communicating the packet to host 141, edge 123 may encapsulate the packet using VXLAN, Geneve, or some other encapsulation format in some examples.

In some implementations, if a return packet is directed from virtual machine 132 to virtual machine 130, edge 123, and host 141 may cache addressing information for the packet and associate the addressing information with a next hop. For example, host 141 may include a cache that directs packets from virtual machine 132 to virtual machine 130 using edge 123, edge 123 may direct packets to edge 120, and edge 120 may forward the packets to the destination host 140.

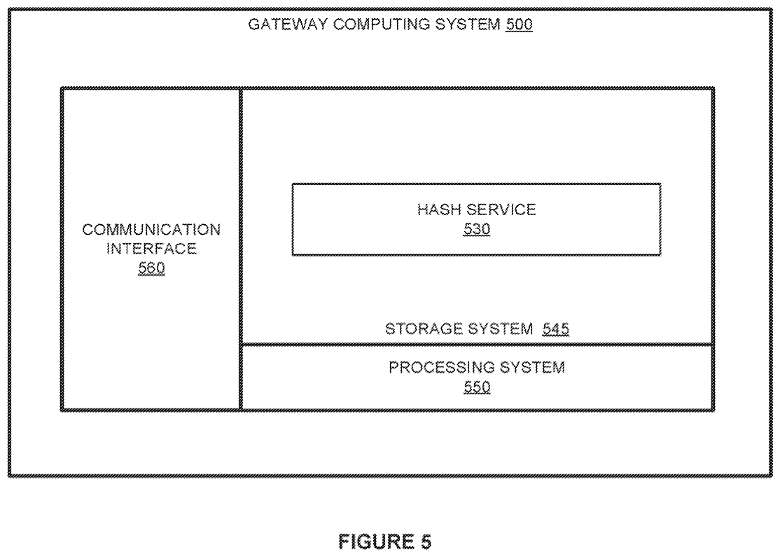

FIG. 5 illustrates a gateway computing system 500 according to an implementation. Computing system 500 is representative of any computing system or systems with which the various operational architectures, processes, scenarios, and sequences disclosed herein for an edge gateway can be implemented. Computing system 500 is an example of edges 120-123 of FIG. 1, although other examples may exist. Computing system 500 includes storage system 545, processing system 550, and communication interface 560. Processing system 550 is operatively linked to communication interface 560 and storage system 545. Communication interface 560 may be communicatively linked to storage system 545 in some implementations. Computing system 500 may further include other components such as a battery and enclosure that are not shown for clarity.

Communication interface 560 comprises components that communicate over communication links, such as network cards, ports, radio frequency (RF), processing circuitry and software, or some other communication devices. Communication interface 560 may be configured to communicate over metallic, wireless, or optical links. Communication interface 560 may be configured to use Time Division Multiplex (TDM), Internet Protocol (IP), Ethernet, optical networking, wireless protocols, communication signaling, or some other communication format—including combinations thereof. Communication interface 560 is configured to communicate with host computing systems and gateways.

Processing system 550 comprises microprocessor and other circuitry that retrieves and executes operating software from storage system 545. Storage system 545 may include volatile and nonvolatile, removable and non-removable media implemented in any method or technology for storage of information, such as computer readable instructions, data structures, program modules, or other data. Storage system 545 may be implemented as a single storage device but may also be implemented across multiple storage devices or sub-systems. Storage system 545 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 550 is typically mounted on a circuit board that may also hold the storage system. The operating software of storage system 545 comprises computer programs, firmware, or some other form of machine-readable program instructions. The operating software of storage system 545 comprises hash service 530 that provides at least method 200 of FIG. 2. The operating software on storage system 545 may further include an operating system, utilities, drivers, network interfaces, applications, or some other type of software. When read and executed by processing system 550 the operating software on storage system 545 directs computing system 500 to operate as described herein.

In at least one implementation, hash service 530 directs processing system 550 to obtain hash information associated with second gateways, wherein the second gateways may reside in separate computing site from the gateway computing system 500. For example, a first computing site with gateway computing system 500 may include one or more gateways, while a second computing site includes a plurality of gateways. One or more of the gateways at the second computing site (e.g., data center) may provide or exchange hash information that is used to determine which gateway of the gateways the packet should be directed to. The hash information is applied to addressing information from a packet to select a desired edge expected by the second gateways.

Once the hash information is provided for the second gateways, hash service 530 further directs processing system 550 to receive a packet from a virtual machine and hash addressing information from the packet to select a destination gateway of the second gateways. For example, a computing environment may include four gateways at a second computing site. When the hash information is applied to the address information from the packet, hash service 530 may identify a value, wherein the value may correspond to a destination of the gateways. For example, a source IP address in the packet may be hashed to identify a first value. This value may then be divided by the number of gateways at the second computing site to determine a reminder value (i.e., a value from zero to three). Each of the values may correspond to a different gateway at the second computing site. Advantageously, by implementing the hash information at gateway computing system 500, the gateways at the second computing system are not required to hash the received packet to “punt” or forward packets to other gateways at the second computing site.

Once the addressing information is hashed to select a destination gateway, hash service 530 also directs processing system 550 to encapsulate the packet and communicate the encapsulated packet to the selected destination gateway. In some implementations, the encapsulation may comprise a secure encapsulation format and header, such as IPsec, wherein gateway computing system 500 establishes a tunnel with each of the second gateways available for selection. Once a destination gateway is selected, the packet is communicated to the selected gateway using the corresponding tunnel endpoint on gateway computing system 500.

In some examples, edge gateway computing system 500 may also provide or distribute hash information associated with gateways at the first computing site to the gateways at the second computing site. The hash information may be used when a communication is initiated at the second computing site to select a gateway at the first computing site. The hash information may include algorithms, keys, or other information associated with determining a destination gateway for a packet. In some implementations, the hash information may be provided to the second gateways using an IKE control plane between the computing elements

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of operating a first gateway, the method comprising:
obtaining hash information associated with second gateways;
receiving a packet from a virtual machine;
hashing addressing information in the packet using the hash information associated the second gateways to select a destination gateway of the second gateways;
encapsulating the packet; and
communicating the encapsulated packet to the destination gateway.

2. The method of claim 1, wherein encapsulating the packet comprises encapsulating the packet using IPsec.

3. The method of claim 1, wherein receiving the packet from the virtual machine comprises receiving the packet encapsulated in a second packet from a host of the virtual machine, and wherein the method further comprises:
decapsulating the second packet to identify the packet.

4. The method of claim 3, wherein the second packet comprises a Generic Network Virtualization Encapsulation (Geneve) header.

5. The method of claim 1, wherein the addressing information comprises a source IP address for the packet.

6. The method of claim 1, wherein the addressing information comprises at least a source IP address for the packet and a destination IP address for the packet.

7. The method of claim 1 further comprising:
receiving a second packet from a second virtual machine;
hashing addressing information in the second packet using the hash information associated with the second gateways to select a second destination gateway of the second gateways;
encapsulating the second packet; and
communicating the encapsulated second packet to the second destination gateway.

8. The method of claim 1, wherein obtaining the hash information associated with the second gateways comprises receiving, via a control plane, the hash information from at least one gateway of the second gateways.

9. A computing apparatus comprising:
a storage system;
a processing system operatively coupled to the storage system; and
program instructions stored on the storage system to operate a first gateway that, when executed by the processing system, direct the computing apparatus to:
obtain hash information associated with second gateways;
receive a packet from a virtual machine;
hash addressing information in the packet using the hash information associated the second gateways to select a destination gateway of the second gateways;
encapsulate the packet; and
communicate the encapsulated packet to the destination gateway.

10. The computing apparatus of claim 9, wherein encapsulating the packet comprises encapsulating the packet using IPsec.

11. The computing apparatus of claim 9, wherein receiving the packet from the virtual machine comprises receiving the packet encapsulated in a second packet from a host of the virtual machine, and wherein the program instructions further direct the computing apparatus to:
decapsulate the second packet to identify the packet.

12. The computing apparatus of claim 11, wherein the second packet comprises a Generic Network Virtualization Encapsulation (Geneve) header.

13. The computing apparatus of claim 9, wherein the addressing information comprises a source IP address for the packet.

14. The computing apparatus of claim 9, wherein the addressing information comprises at least a source IP address for the packet and a destination IP address for the packet.

15. The computing apparatus of claim 9, wherein the program instructions further direct the computing apparatus:
receive a second packet from a second virtual machine;
hash addressing information in the second packet using the hash information associated with the second gateways to select a second destination gateway of the second gateways;
encapsulate the second packet; and
communicate the encapsulated second packet to the second destination gateway.

16. The computing apparatus of claim 9, wherein obtaining the hash information associated with the second gateways comprises receiving, via a control plane, the hash information from at least one gateway of the second gateways.

17. A system comprising:
a first gateway at a first computing site; and
second gateways at a second computing site communicatively coupled to the first gateway;
the first gateway configured to:
obtain hash information associated with the second gateways;
receive a packet from a virtual machine;
hash addressing information in the packet using the hash information associated the second gateways to select a destination gateway of the second gateways;
encapsulate the packet; and
communicate the encapsulated packet to the destination gateway.

18. The system of claim 17, wherein encapsulating the packet comprises encapsulating the packet using IPsec.

19. The system of claim 17, wherein receiving the packet from the virtual machine comprises receiving the packet encapsulated in a second packet from a host of the virtual machine, and wherein the first gateway is further configured to:
decrypt the second packet to identify the packet.

20. The system of claim 17, wherein obtaining the hash information associated with the second gateways comprises receiving, via a control plane, the hash information from at least one gateway of the second gateways.
